(19) United States
(12) Patent Application Publication
(10) Pub. No.: US 2014/0185914 A1
(43) Pub. Date: Jul. 3, 2014

(54) DEVICE FOR DETERMINING SURFACE DEFECTS

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/092,934

(22) Filed: Nov. 28, 2013

(30) Foreign Application Priority Data
Dec. 27, 2012 (TW) 101150703

(51) Int. Cl. G06T 7/00

(52) U.S. Cl. CPC G06T 7/001
USPC 382/141

(57) ABSTRACT

A device for determining the existence or absence of surface defects of a product includes a base, a rotatable platform, a support member, an image capturing unit, a light source unit, and a processing unit. The rotatable platform includes a main body supporting the product and a driving unit rotating the main body with respect to the base, thereby orienting the product placed thereon in different orientations. The support member carries an image capturing unit which captures different orientations of the rotating product as images. The light source unit illuminates the rotating product. The captured images of the product are analyzed and matched against similar orientations of a defect-free model product, any discrepancies leading to a determination that the product has surface defects.

### CROSS-REFERENCE TO RELATED APPLICATION

This application is related to one co-pending application entitled, “DEVICE FOR DETERMINING SURFACE DEFECTS”, filed **** (Atty. Docket No. US49259).

### BACKGROUND

1. Technical Field

The present disclosure relates to devices and, more particularly, to a device for determining whether or not a product has surface defects.

2. Description of Related Art

The high production performances and demanding quality requirements render necessary monitoring systems after manufacturing the product. For example, to determine whether or not a product has any surface defects, such as a scratch or smudge. Such determining procedures of the surface defects are not economically feasible by means of manual labor. Technical illogic and possibility of errors exist where personnel are used for monitoring.

Therefore, what is needed is a device to solve the problems described above.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the present disclosure. Moreover, in the drawings, like reference numerals designate corresponding parts throughout the views, and all the views are schematic.

FIG. 1 is an isometric view of a device for determining surface defect, in accordance with an exemplary embodiment.

FIG. 2 is a schematic block diagram of the device of FIG. 1.

### DETAILED DESCRIPTION

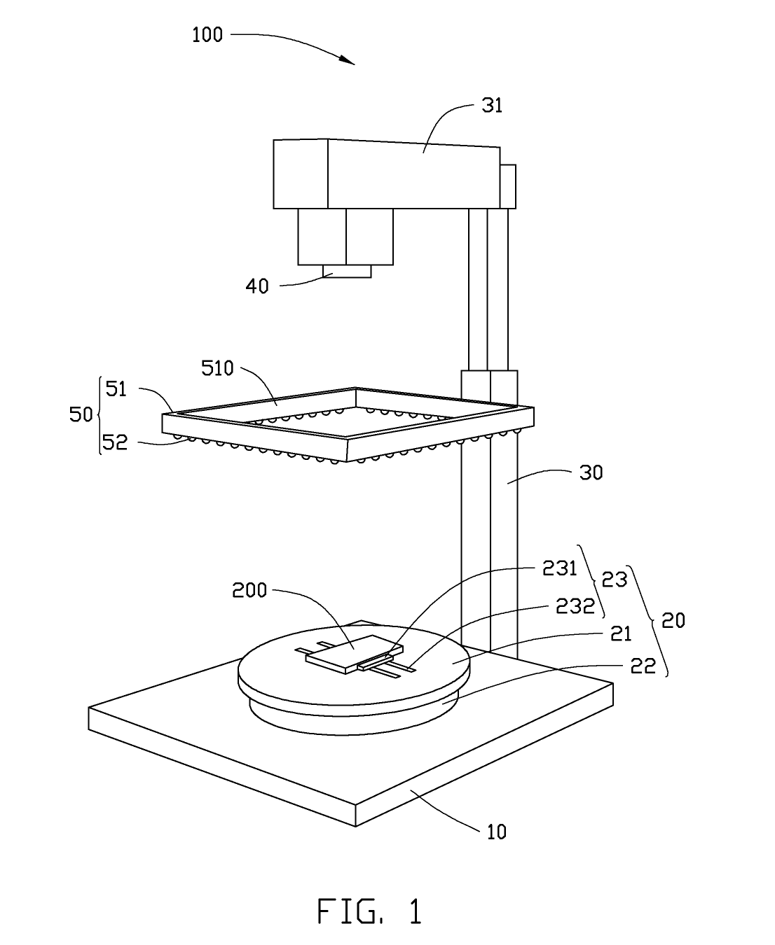

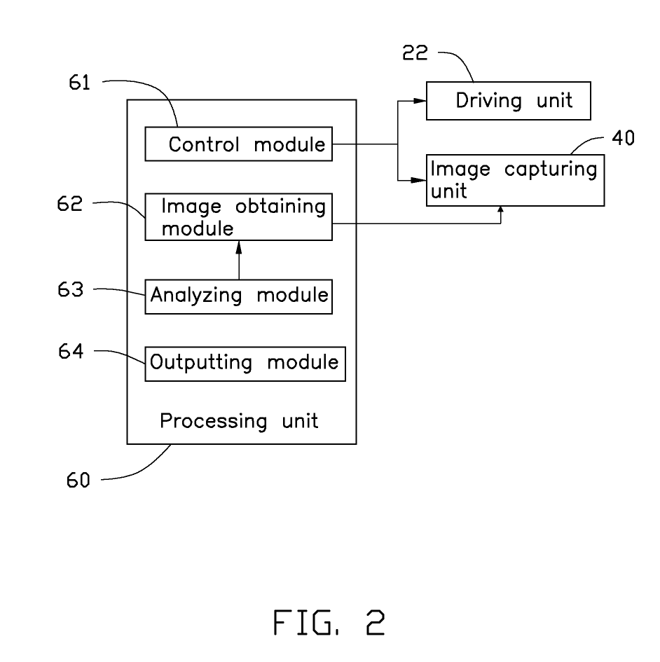

FIGS. 1-2 show an exemplary embodiment of a device 100 for determining whether or not a product 200 has any surface defects (e.g., a scratch or other non-uniformity). The device 100 includes a base 10, a rotatable platform 20, a support member 30, an image capturing unit 40, a light source unit 50, and a processing unit 60.

The rotatable platform 20 includes a main body 21 and a driving unit 22. The main body 21 supports the product 200. The driving unit 22 is securely connected to the base 10 and drives the main body 21 to rotate with respect to the base 10, thereby orienting the product 200 placed thereon in different orientations. In this embodiment, the driving unit 22 is a motor. In an alternative embodiment, the driving unit 22 may be a gear engaged with main body 21. When driven by a motor, the gear rotates the main body 21. In the embodiment, a fixing member 23 is connected to a top surface of the main body 21, and the product 200 is secured to the main body 21 through the fixing member 23.

In this embodiment, the fixing member 23 includes two fixing blocks 231 and two elastic elements 232 attached to the main body 21 and abutting against the fixing blocks 231. The distance between the two fixing blocks 231 is smaller than a width of the product 200. When the product 200 is placed between the two fixing blocks 231, the elastic elements 232 are elastically deformed, causing the fixing blocks 231 to firmly grip the product 200, and thus securing the product 200 on the main body 21. The manner of connection and interaction between the main body 21 and the product 200 is not limited and can be varied according to need. In an alternative embodiment, the fixing member 23 can be omitted, and the product 200 be directly placed on the main body 21.

The support member 30 is perpendicular to the base 10 and connected to the base 10 at an bottom end portion. An arm 31 protrudes from the top end of the support member 30, and the arm 31 is arranged above the main body 21 and parallel to the main body 21.

The image capturing unit 40 is connected to the arm 31, and faces the main body 21 to capture images of the product 200 in the different orientation. In the embodiment, the image capturing unit 40 is a camera.

The light source unit 50 is arranged between the image capturing unit 40 and the main body 21. The light source unit 50 includes a frame 51 connected to the support member 30 via one edge thereof and a number of point light sources 52 (such as LEDs) arranged along the frame 51. The frame 51 is parallel to the main body 21 and defines an opening 510. In this embodiment, the frame 51 is a hollow rectangular or annular structure. Light reflected from the product 200 passes through the opening 510 and travels to the image capturing unit 40. The point light sources 52 emits light to provide sufficient light for the image capturing unit 40 to capture high quality images of the product 200. In this embodiment, a mechanical switch (not shown) is used to turn on or off the point light sources 52.

The processing unit 60 is arranged inside the base 10 or the support member 30. The processing unit 60 includes a control module 61, an image obtaining module 62, and an analyzing module 63, which are collection of instructions and executed by the processing unit 60.

The control module 61 communicates with the driving unit 22 and controls the driving unit 22 to drive the main body 21 to rotate. The control module 61 further communicates with the image capturing unit 40 to capture the images of the product 200 in the different orientations. In the embodiment, the control module 61 controls the driving unit 22 to drive the main body 21 according to stored parameters. In an implementation, the stored parameters include the total number of times that the main body 21 is driven to rotate by the driving unit 22, the angular rotation that the main body 21 undergoes each time, the time interval between each two times that the main body 21 is driven to rotate. Specifically, the stored parameters are preset by a user via a peripheral input device (not shown), such as a keyboard.

The image obtaining module 62 obtains the captured images of the product 200.

The analyzing module 63 determines whether or not the product 200 has any surface defects according to the obtained images. In the embodiment, the analyzing module 63 compares the obtained images with a number of reference images showing different orientations of a standard product. If each and every one of the obtained images matches one of the stored images of the standard product, the analyzing module 63 determines that the product 200 has no surface defects. In an alternative embodiment, the analyzing module 63 may apply Fourier transform to the obtained images to obtain a number of frequency spectrograms, and determine whether or not the product 200 has a surface defect according to the obtained frequency spectrograms. The technology of determining surface defects on a product according to the frequency spectrograms is known in the art, such as the subject matter of U.S. Patent Application Patent No. 007069154, which is herein incorporated by reference.

In the embodiment, the processing unit 60 further includes an outputting module 64, and the outputting module 64 outputs the result determined by the analyzing module 63 to an electronic device (not shown). Specifically, the output determining result of the analyzing module 63 can be an audio file or a text message.

In an alternative embodiment, the processing unit 60 may be applied in a peripheral device (e.g., a computer) which communicates with the device 100 via a wireless access interface or a wired access interface.

Although the present disclosure has been specifically described on the basis of the exemplary embodiments thereof, the disclosure is not to be construed as being limited thereto. Various changes or modifications may be made to the embodiments without departing from the scope and spirit of the disclosure.

What is claimed is:

1. A device for determining whether or not a product has any surface defects, the device comprising:
a base;
a rotatable platform comprising a main body and a driving unit, the main body configured for supporting the product, and the driving unit being securely connected with the base and configured for driving the main body to rotate with respect to the base, thereby orienting the product placed thereon in different orientations;
a support member connected to the base, and an arm protruding from the support member;
an image capturing unit connected to the arm, and facing the main body to capture images of the product in the different orientations;
a light source unit arranged between the image capturing unit and the main body, and configured to illuminate the product; and
a processing unit comprising:
a control module configured to control the driving unit to drive the main body to rotate, and further control the image capturing unit to capture the images of the product in the different orientations;
an image obtaining module configured to obtain the captured images of the product; and
an analyzing module configured to determine whether or not the product has any surface defects according to the obtained images.

2. The device as claimed in claim 1, wherein the driving unit comprises a motor.

3. The device as claimed in claim 1, wherein the driving unit comprises a gear engaged with main body, and the gear is configured to rotate the main body.

4. The device as claimed in claim 1, further comprising a fixing member connected to a top surface of the main body, and the product is secured to the main body through the fixing member.

5. The device as claimed in claim 4, wherein the fixing member comprises two fixing blocks and two elastic elements attached to the main body and abutting against the fixing blocks, a distance between the two fixing blocks is smaller than a width of the product, and the elastic elements are elastically deformed, causing the fixing blocks to grip the product placed between the two fixing blocks.

6. The device as claimed in claim 1, wherein the support member is perpendicular to the base, and the arm protrudes from a top end of the support member.

7. The device as claimed in claim 1, wherein the image capturing unit is a camera.

8. The device as claimed in claim 1, wherein the light source unit comprises a frame connected to the support member and a plurality of point light sources arranged along the frame.

9. The device as claimed in claim 8, wherein the frame is parallel to the main body and defines an opening for allowing light reflected from the product to pass therethrough and travel to the image capturing unit.

10. The device as claimed in claim 1, wherein the processing unit is arranged inside the base or the support member.

11. The device as claimed in claim 1, wherein the control module controls the driving unit to drive the main body according to a plurality of stored parameters, and the stored parameters comprise a total number of times that the main body is driven to rotate by the driving unit, an angular rotation that the main body undergoes each time, and a time interval between each two times that the main body is driven to rotate.

12. The device as claimed in claim 1, wherein the analyzing module compares the obtained images with a plurality of reference images showing different orientations of a standard product, and determines that the product has no surface defects if each obtained image matches one of the stored images of the standard product.

13. The device as claimed in claim 1, wherein the analyzing module is configured to apply Fourier transform to the obtained images to obtain a plurality of frequency spectrograms, and determine whether the product has any surface defects according to the obtained frequency spectrograms.

14. The device as claimed in claim 1, wherein the processing unit further comprises an outputting module, and the output module is configured to output a result determined by the analyzing module to an electronic device.
